(19) United States
(12) Patent Application Publication
(10) Pub. No.: US 2010/0046112 A1
(43) Pub. Date: Feb. 25, 2010

(54) STORAGE DEVICE, STORAGE-DEVICE CONTROLLING METHOD, AND CONTROL CIRCUIT FOR STORAGE DEVICE

(75) Inventor: Hiroshi Ishiyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/483,005

(22) Filed: Jun. 11, 2009

(30) Foreign Application Priority Data
Aug. 25, 2008 (JP) 2008-214971

(51) Int. Cl. G11B 33/14

(52) U.S. Cl. 360/97.02; G9B/33.035

(57) ABSTRACT

A storage device includes: a head that reads and writes data stored in a storage medium; an arm that holds the head; a voice coil motor formed of a coil and a magnet, the voice coil motor that lets a current flow through the coil to move the arm; a disk enclosure that accommodates the storage medium, the head, the arm, and the voice coil motor; a temperature sensor that detects a temperature in the disk enclosure; and a controller that determines an amount of current flowing through the coil for moving the head to a target position on the storage medium and estimates a temperature of the coil from the amount of current flowing through the coil, the temperature in the disk enclosure detected by the temperature sensor, and a predetermined value.

### CROSS-REFERENCE TO RELATED APPLICATION

This application is based upon and claims the benefit of priority of the prior Japanese Patent Application No. 2008-214971, filed on Aug. 25, 2008, the entire contents of which are incorporated herein by reference.

### FIELD

The embodiments discussed herein are directed to a storage device, a storage-device controlling method, and a control circuits for storage device.

### BACKGROUND

An example of a storage device is a magnetic disk device that records information on a disk applied with a magnetic material. In the magnetic disk device, a voice coil motor (VCM) is used to move a head to a target position. The VCM operates by letting a current flows through a coil. With the flow of the current, the temperature of the coil increases. The coil at high temperature causes degradation in performance due to an increase of the resistance value of the coil or causes dust to come from the coil.

A technology of estimating the temperature of the coil from a current value to be applied to the VCM and a counter electromotive force occurring from the VCM is disclosed in Japanese Laid-open Patent Publication No. 2003-85902. There is also a technology of estimating the temperature of the coil by using a thermistor placed in an enclosure of the storage device.

However, in the technology of obtaining a counter electromotive force of the coil of the VCM, a circuit that detects the counter electromotive force is required. Moreover, in the technology of obtaining the temperature by using a thermistor, a difference between the temperature obtained from the thermistor and the actual temperature of the coil is large.

### SUMMARY

According to an aspect of the invention, a storage device includes a head that reads and writes data stored in a storage medium; an arm that holds the head; a voice coil motor that includes a coil and a magnet, and moves the arm according to current flowing through the coil; a disk enclosure that accommodates the storage medium, the head, the arm, and the voice coil motor; a temperature sensor that detects a temperature in the disk enclosure; and a controller that determines an amount of current flowing through the coil for moving the head to a target position on the storage medium and estimates a temperature of the coil from the amount of current flowing through the coil, the temperature in the disk enclosure detected by the temperature sensor, and a predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of the configuration of a magnetic disk device according to an embodiment;

FIG. 2 is a cross-section view of a VCM along A-A′ in FIG. 1;

FIG. 3 is a diagram of the VCM viewed from top of a disk enclosure;

FIG. 4 is a diagram for explaining a waveform of a current flowing through a coil at the time of a seek operation of moving across one thirds of the number of tracks;

FIG. 5 is a drawing for explaining a waveform of a current flowing though the coil at the time of a seek operation of moving across one eighths of the number of tracks;

FIG. 6 is a drawing for explaining a seek move distance;

FIG. 7 is a block diagram of a control over a seek operation;

FIG. 8 is a graph representing a relation between a Joule loss and heat of a coil;

FIG. 9 is a graph representing a relation between an indicator current value and heat of the coil;

FIG. 10 is a graph representing a relation between a moving distance across tracks in a seek operation, and an actual measurement value in temperature increase of the coil and an estimated value in temperature increase of the coil according to the present embodiment; and

FIG. 11 is a flowchart of a control change process in a seek operation.

### DESCRIPTION OF EMBODIMENT

A preferred embodiment of the present invention will be explained with reference to accompanying drawings.

Magnetic Disk Device

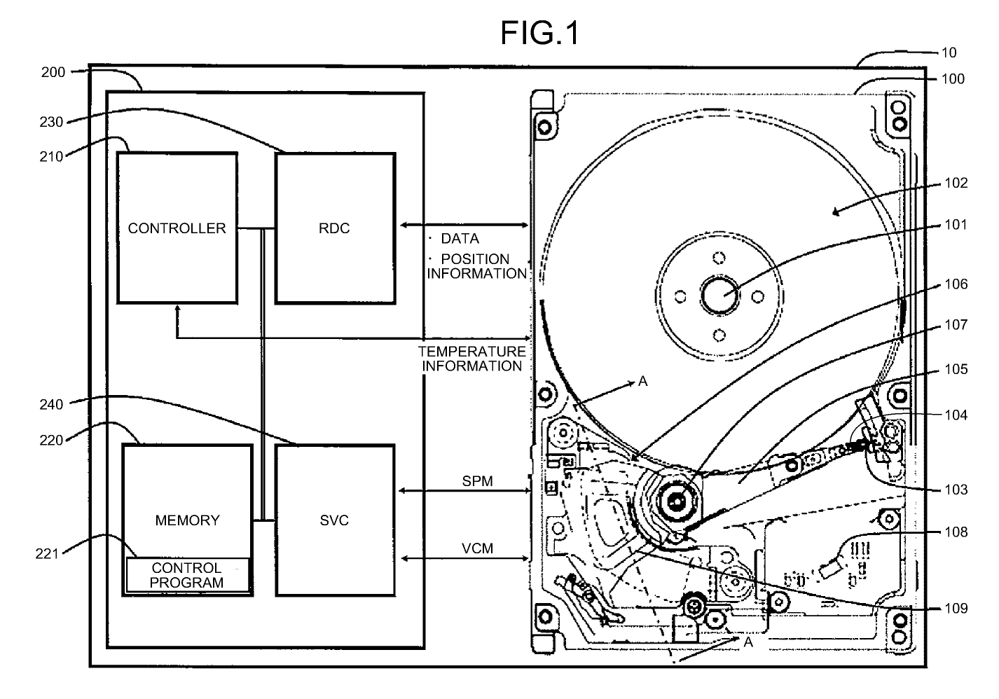

FIG. 1 is a diagram of the configuration of the magnetic disk device 10 according to an embodiment. The configuration of the entire magnetic disk device and its main functional units are explained. First, the configuration of the entire magnetic disk device is explained. The magnetic disk device 10 includes a disk enclosure 100 and a print board circuit assembly 200. The magnetic disk device is connected to an upper device, and performs processes, such as reading and writing data, according to an instruction from the upper device.

Configuration of Disk Enclosure

The disk enclosure 100 includes a spindle motor (SPM) 101, a magnetic disk 102, a magnetic head 103, an arm 105, a voice coil motor (VCM) 106, a rotational shaft 107, and a thermistor 108.

The SPM 101 provided to the disk enclosure 100 has mounted thereon at least one magnetic disk 102. The SPM 101 causes the magnetic disk 102 to rotate. The magnetic disk 102 rotates about the SPM 101.

The magnetic disk 102 records data and servo pattern data (position information) allowing the magnetic head 103 to specify a position on the magnetic disk 102. The magnetic disk 102 is, for example, a disk applied with a magnetic material. Data is recorded onto and deleted from the magnetic disk 102 by the magnetic head 103.

The magnetic head 103 reads the data or servo pattern data recorded on the magnetic disk 102, and writes data onto the magnetic disk 102. The magnetic head 103 is mounted on a head slider 104.

The head slider 104 floats over the magnetic disk 102 with an airflow occurring from the rotating magnetic disk so as to keep a predetermined height. The head slider is mounted on a tip end of the arm 105. The arm 105 performs a rotating operation about the rotational shaft by the VCM 106. The VCM 106 that drives the arm 105 is located on a side opposite to the arm 105 with respect to the rotational shaft 107. The rotation of the arm 105 moves the head slider 104 in a direction of the radius of the magnetic disk 102.

The thermistor (temperature sensor) 108 is an element with its resistance value changed with temperature. A controller 210 detects the temperature inside the disk enclosure 100 from the resistance value of the thermistor 108. The thermistor 108 is disposed, for example, near an interface connecting the disk enclosure 100 and the print board circuit assembly 200. The interface transfers information between the print board circuit assembly 200 and the disk enclosure 100. The interface transfers, for example, a value of current flowing through the coil 109, information read by the magnetic head 103 from the magnetic disk 102, information to be written by the magnetic head into the magnetic disk 102, and temperature information detected by the thermistor 108.

The thermistor 108 is placed to detect an environmental temperature inside the disk enclosure 100. For the magnetic disk device 10, a range of the environment temperature at which the magnetic disk device 10 operates normally is defined. For example, the range is 5 degrees Celsius to 55 degrees Celsius. Therefore, the operation outside the range of the environment temperature at which the magnetic disk device 10 normally operates will cause a failure in the magnetic disk device 10. The thermistor 108 outputs temperature information about temperature inside the disk enclosure 100 of the magnetic disk device 10. With the themistor 108, the controller 210 can detect that the environmental temperature goes outside of the range of normal operation. By performing a process according to the environmental temperature, the controller 210 prevents a failure in the magnetic disk device 10.

Also, vibration properties of mechanical components, such as the disk enclosure 100, the SPM 101, the magnetic disk 102, the magnetic head 103, the arm 105, the VCM 106, and the rotational shaft 107, fluctuate depending on the environment temperature. The controller 210 addresses such fluctuations of mechanical properties due to changes in environment temperature by changing a servo parameter based on the temperature information obtained from the resistance value of the thermistor 108.

The thermistor 108 is an element placed to detect an environment temperature inside the disk enclosure 100. There is a time difference between an increase in temperature of the coil 109 and an increase in temperature of air inside the magnetic disk device 10. Therefore, the temperature of the coil 109 cannot be accurately detected only with the thermistor 108.

In one technology, the temperature of the coil 109 is measured by mounting a thermistor directly on the coil 109. However, in the magnetic disk device 10, reduction in access time and low power consumption are desired. To achieve such reduction in access time and low power consumption, the weight of the coil 109 has to be reduced. Therefore, an increase in weight by mounting a thermistor directly on the coil 109 goes against reduction in access time and low power consumption. Moreover, a thermistor dedicated to measurement of a temperature of the coil 109 has to be newly required.

Voice Coil Motor

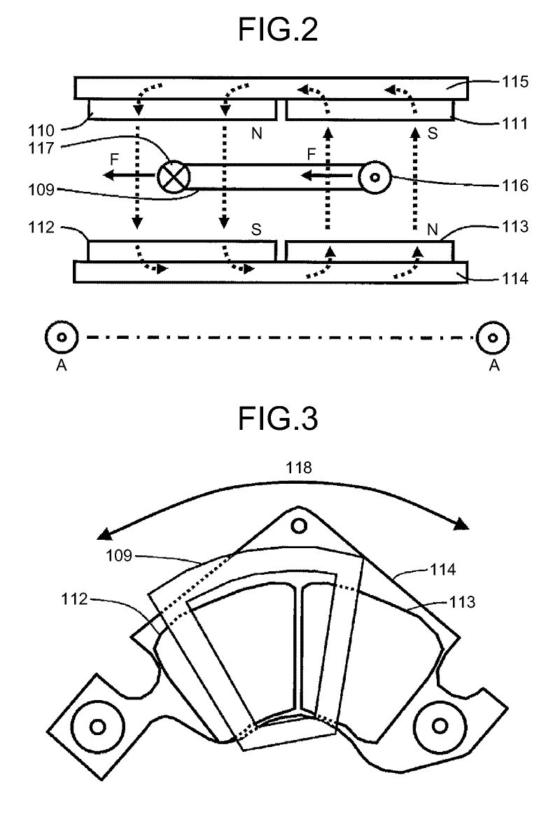

FIG. 2 is a cross-section view of the VCM along A-A′ in FIG. 1. The VCM 106 includes an upper yoke 115, an upper first magnet 110, an upper second magnet 111, a lower yoke 114, a lower first magnet 112, a lower second magnet 113, and the coil 109 interposed between the upper first magnet 110 and the upper second magnet 111 and the lower first magnet 112 and the lower second magnet 113. The upper first magnet 110 and the upper second magnet 111 are mounted on the upper yoke 115, whilst the lower first magnet 112 and the lower second magnet 113 are mounted on the lower yoke 114.

It is assumed that the polarity of the upper first magnet 110 facing the coil 109 is “N”, the polarity of the lower first magnet 112 facing the coil 109 is “S”, the polarity of the lower second magnet 113 facing the coil 109 is “N”, and the polarity of the upper second magnet 111 facing the coil 109 is “S”. Dotted lines in FIG. 2 represent magnetic fields.

The coil 109 is mounted on an opposite side of the rotational shaft 107 of the magnetic head 103 mounted on the arm 105. Between the upper first magnet 110 and the lower first magnet 112 and between the upper second magnet 111 and the lower second magnet 113, a space equal to or larger than the thickness of the coil 109 is provided. When a current flows through the coil 109 in directions 116 and 117, a force in a direction of “F” occurs to the coil 109 due to electromagnetic induction. As a result, the arm 105 rocks about the rotational shaft 107. FIG. 3 is a diagram of the VCM viewed from top of the disk enclosure 100. The coil 109 can move in a direction 118.

Coil

The coil 109 produces heat with the flowing of the current. That is, the passage of current through the coil 109 that moves the arm 105 about the rotational shaft 107 causes the coil 109 to produce heat. When a current for the magnetic head 103 to perform a seek operation is successively supplied to the coil 109, the temperature of the coil 109 becomes high. The resistance of the coil 109 changes according to the temperature of the coil 109. When the temperature of the coil 109 increases, the resistance value of the coil 109 increases. With this increase in resistance value of the coil 109, it is required to supply a larger amount of current to move the coil 109 than the amount of current required at normal temperature. This results in a further increase in temperature of the coil 109.

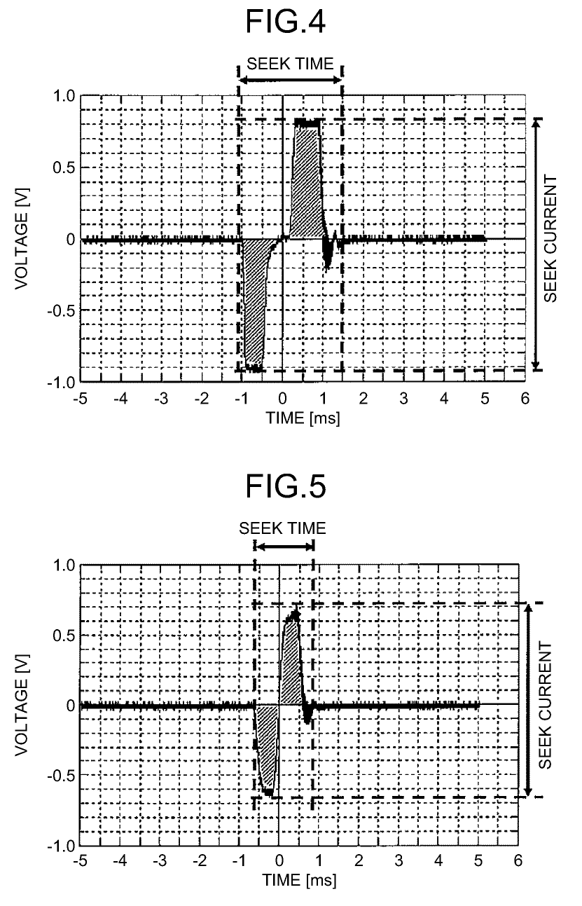

There are various types of seek operations in the magnetic disk device 10. A seek operation with a large amount of current flowing through the coil 109 per unit time tends to increase the temperature of the coil 109. FIG. 4 is a diagram for explaining a waveform of a current flowing through the coil 109 at the time of a seek operation of moving across one thirds of the number of tracks. FIG. 5 is a drawing for explaining a waveform of a current flowing though the coil 109 at the time of a seek operation of moving across one eighths of the number of tracks. The horizontal axis in FIGS. 4 and 5 represents time, whilst the vertical axis therein represents voltage corresponding to the current flowing through the coil. In the seek operation of moving across one thirds of the number of tracks, the current flows through the coil 109 from approximately −1.0 millisecond to approximately +1.5 milliseconds. In the seek operation of moving across one eighths of the number of tracks, the current flows through the coil 109 from approximately −0.6 millisecond to approximately +0.8 millisecond. In the seek operation of moving across one thirds of the number of tracks, a current flows through the coil 109 corresponding to a voltage from approximately −0.9 volt to approximately +0.8 volt. In the seek operation of moving across one eighths of the number of tracks, a current flows through the coil 109 corresponding to a voltage from approximately −0.6 volt to approximately +0.7 volt. In the seek operation of moving across tracks exceeding one thirds of the number of all tracks on the magnetic disk 102, the amount of current required is large. Upon the start of the seek operation, a large current flows through the coil 109 so as to accelerate the moving speed of the magnetic head 103 to a target speed. When the moving speed of the magnetic head 103 reaches the target speed, a large current flows through the coil so as to decelerate the moving speed of the magnetic head 103 to follow the target position. Repeating such a seek operation of moving across tracks exceeding one thirds of the number of all tracks significantly increases the temperature of the coil. Hatched areas in FIGS. 4 and 5 represent integration values with the time of the value of current flowing through the coil 109. The amount of current flowing through the coil 109 is large in a large hatched area.

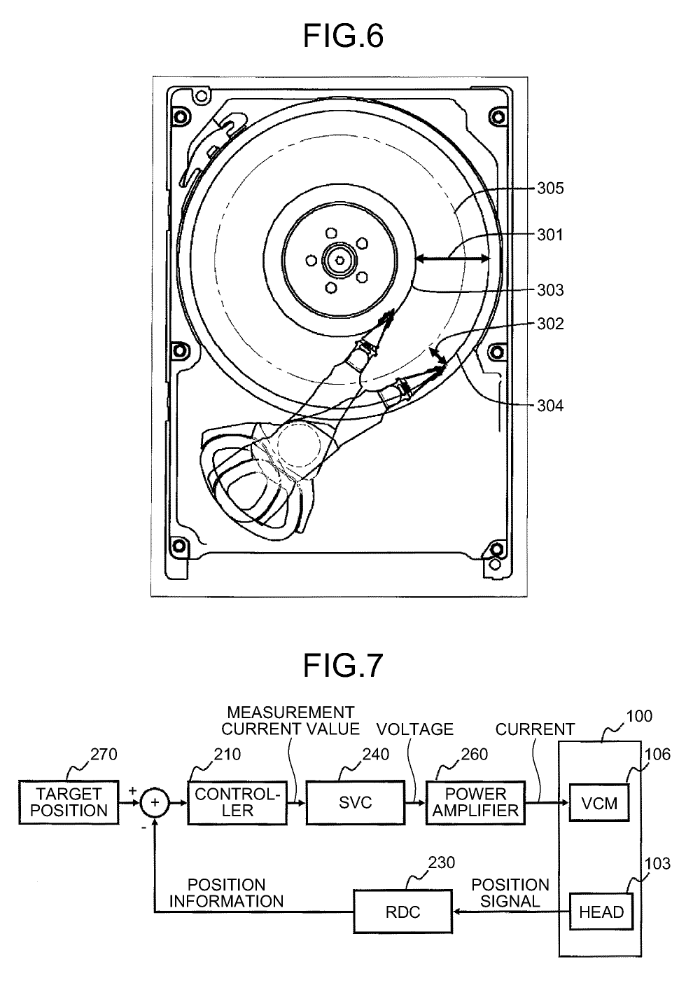

FIG. 6 is a drawing for explaining a seek move distance. The magnetic disk 102 is provided thereon a plurality of tracks in a circumferential direction. 303 denotes a most-inner track, whilst 304 denotes a most-outer track. 305 is a track in a radial direction of the magnetic disk 102 on an inner side by one thirds of the number of all tracks from the track 304. 301 denotes a distance in a radial direction between the most-inner track and the most-outer track on the magnetic disk 102. 302 represents a distance in a radial direction for one thirds of the number of all tracks.

Print Board Circuit Assembly

The print board circuit assembly 200 in FIG. 1 includes the controller 210, a memory 220, an RDC 230, and an SVC 240.

The controller 210 is, for example, a Central Processing Unit (CPU), a Micro Controller Unit (MCU), a Micro Processing Unit (MPU), or a hard disk controller. The controller 210 controls the entire magnetic disk device 10. The controller 210 obtains the temperature information detected by the thermistor 108. In response to an instruction obtained from the upper device, the controller 210 performs various controls over the magnetic disk device 10. For example, the controller 210 performs a process of activating the SPM 101 and the VCM 106 in the disk enclosure 100, a process of reading data by the magnetic head 103 from the magnetic disk 102 in response to a data reading instruction from the upper device, and a process of writing data by the magnetic head 103 onto the magnetic disk 102 in response to a data writing instruction from the upper device.

The controller 210 is connected to the SVC 240. The controller 210 outputs to the SVC 240 a control signal regarding the VCM 106 and the SPM 101. The SVC 240 controls the operations of the VCM 106 and the SPM 101 in response to an instruction from the controller 210.

The controller 210 is also connected to the RDC 230. The controller 210 obtains from the RDC 230 data stored in the magnetic disk 102 and position information of the magnetic head 103. The controller 210 outputs data stored in the magnetic disk 102 to the RDC 230. The RDC 230 obtains an output signal from the magnetic head 103, and demodulates the output signal to obtain read information. The RDC 230 outputs the read information to the controller 210. The read information is data stored in the magnetic disk 102 and the position information.

The controller 210 outputs write information to the RDC 230. Upon obtaining the write information, the RDC 230 converts the write information to a write signal. The magnetic head 103 records the write signal obtained from the RDC 230 onto the magnetic disk as a magnetized pattern.

The memory 220 has stored therein a control program 221 to be executed by the controller 210, operation results, constants, and others. The memory 220 has stored therein an amount of current supplied to the VCM 106, constants for estimating of the temperature of the coil, and others.

Procedure of Seek Operation

Next, alignment control over the magnetic head 103 by the magnetic disk device 10 is explained. FIG. 7 is a block diagram of a control over a seek operation. The controller 210 outputs a value of current flowing through the coil 109 to the SVC 240 at servo intervals. According to the orientation of the current flowing through the coil 109 of the VCM 106 and its magnetic-field orientation, the coil 109 moves. The movement of the coil 109 moves the magnetic head 103.

The magnetic disk device 10 performs a seek operation according to the following procedure, for example. The controller 210 obtains from the RDC 230 position information of the current position read by the magnetic head 103 from the magnetic disk 102. Upon an input of information 270 of a target position, the controller 210 calculates a move distance from a difference between the current position of the magnetic head 103 and the target position. From the move distance, the controller 210 finds an indicator current value required for seek operation, and then outputs the found value to the SVC 240. The SVC 240 then converts the indicator current value to a voltage value for transmission to a power amplifier 260. The power amplifier 260 then outputs to the coil 109 a current corresponding to the voltage. The magnetic head 103 then moves according to the movement of the coil 109. The current flowing through the coil 109 at the time of a seek operation is determined by the speed and the distance to the target position. Through the coil 109, a current flows in a direction in which the moving speed of the magnetic head 103 is accelerated to a target speed. After the moving speed of the magnetic head 103 reaches the target speed, a current flows through the coil 109 in a direction in which the moving speed is decelerated according to the remaining move distance. With this, the controller 210 can move the magnetic head 103 to the target position.

Procedure of Measuring Temperature of Coil

Next, the procedure of the controller 210 detecting the temperature of the coil 109 is explained. The controller 210 stores in the memory 220 a sum value of indicator current values flowing through the coil 109. The controller 210 then estimates a temperature of the coil 109 at predetermined time intervals. The controller 210 then clears the sum values of the indicator current values in the memory 220. By repeating this process, the controller 210 can estimate the temperature of the coil 109 at predetermined intervals.

The controller 210 finds a temperature of the coil 109 at predetermined time intervals. Equation (1) is an equation for calculating the temperature of the coil.

T_{coil}−Tₜₕ=θ·R(T_{coil})·i² (1)

where T_{coil} represents a temperature (degree Celsius) of the coil 109; Tₜₕ represents a temperature (degree Celsius) in the disk enclosure 100 output from the thermistor 108; θ represents a thermal resistance (degree Celsius/W), which is an amount of temperature increase with respect to a calorific value per unit time; R(T_{coil}) represents a resistance value (Ω) of the coil 109 corresponding to the temperature of the coil 109; and i represents a current value. The current value is a value read by firmware executed by the controller 210, and is, for example, an indicator current value output from the controller 210. A temperature difference between the temperature “T_{coil}” of the coil 109 and the temperature “Tₜₕ” of the thermistor 108 is found by multiplying the coil resistance “R(T_{coil})” by the square of the current “i” to obtain a Joule loss and multiplying the obtained Joule loss by the thermal resistance “θ”.

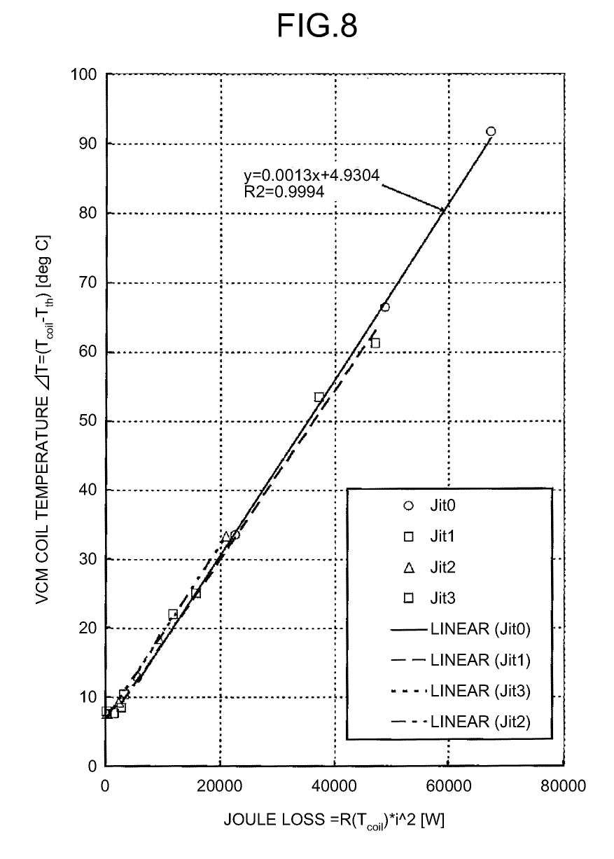

The thermal resistance θ according to the present embodiment is obtained through an experiment. FIG. 8 is a graph representing a relation between a Joule loss and heat of the coil 109. The horizontal axis represents a Joule loss of the coil 109, whilst the vertical axis represents a difference between a measurement value of the temperature of the coil 109 and the temperature from the thermistor 108. The thermal resistance θ is detected by measuring the temperature of the coil 109 when the seek operation is repeated.

What is measured is a Joule loss of the coil 109 when the seek operation speed is changed, and a difference between the measurement value of the temperature of the coil 109 and the temperature from the thermistor 108. The latency in the seek operation increases as Jit0 to Jit3. Therefore, the moving speed of the magnetic head 103 is delayed due to the seek operation as Jit0 to Jit3. During Jit0 to Jit3 in FIG. 8, the speed of the seek operation is changed by changing a timing of a Just-In-Time (JIT) seek. The JIT seek is a seek operation in consideration of rotation latency. In the JIT seek, without changing a time period from the time when starting the seek operation to the time when reaching the target position in consideration of a circumferential direction, vibrations and noise of the magnetic disk device 10 due to the seek operation can be suppressed, and also the amount of current flowing through the coil 109 can be reduced.

First, a measurer measures the value of the Joule loss and a difference between the measurement value of the temperature of the coil 109 and the temperature from the thermistor 108 at this time in a plurality of seek operations. Next, from the measurement results, the measurer finds an approximate straight line for each seek operation when measuring a plurality of seek operations. The gradient of the found approximate straight line corresponds to the thermal resistance θ. The gradient of each approximate straight line in FIG. 8 is approximately 0.0013.

From the explanation above, the thermal resistance θ is a fixed value, and therefore the varying values in Equation (1) are T_{coil}, Tₜₕ, R(T_{coil}), and i. The values of Tₜₕ and i are obtainable. Therefore, R(T_{coil}) has to be obtained. The resistance “R(T_{coil})” of the coil 109 varying with temperature is found by the following Equation (2).

R(T_{coil})=R_{A}{1+C(T_{coil}−A)} (2)

where R_{A} represents a resistance value (Ω) of the coil at a reference temperature. The reference temperature is an ordinary temperature, for example. The ordinary temperature “A” is generally a room temperature, and 20 degrees Celsius, for example. C represents a temperature coefficient of the resistance of the coil. For example, when the coil is a copper wire, the temperature coefficient is 0.042. T_{coil} represents a temperature of the coil 109. A represents a reference temperature (degree Celsius) (Ω). R_{A}, A, and C are fixed values. Therefore, the resistance value of the coil 109 changes with temperature of the coil 109. R(T_{coil}) is found by adding the value of R_{A} and a value obtained by multiplying a difference between T_{coil} and A by C and then further multiplying the multiplication result by R_{A}. The varying values in Equation (2) are R(T_{coil}) and T_{coil}. By substituting Equation (2) into R(T_{coil}) in Equation (1), Equation (3) can be obtained as an equation for calculating T_{coil}. The varying values in Equation 3 are T_{coil}, Tₜₕ, and i.

$${T}_{coil} = \frac{θ {R}_{A} {i}^{2} - A C θ {R}_{A} {i}^{2} + {T}_{th}}{1 - C θ {R}_{A} {i}^{2}} \qquad ( 3 )$$

where T_{coil} is found by dividing a first value by a second value, the first value being obtained by subtracting a third value from a fourth value, the second value obtained by subtracting a fifth value from 1, the third value being obtained by multiplying A by C, θ, R_{A}, and the square of i, the fourth value obtained by adding a sixth value and Tₜₕ together, the fifth value being obtained by multiplying θ by R_{A}, and the square of i, and the sixth value being obtained by multiplying θ by R_{A}, and the square of i. In Equation (3), since the resistance value of the coil varying with the temperature of the coil 109 is taken into consideration, the temperature of the coil 109 can be accurately estimated.

Next, the case of calculating the temperature of the coil 109 in a simple manner is explained. An equation for calculating the temperature of the coil 109 in a simple manner is as follows, for example:

T_{coil}−Tₜₕ=Kₛ·i² (4)

where T_{coil} represents a temperature of the coil; Tₜₕ represents a temperature output from the thermistor; i represents a current to be supplied to the coil 109; and Kₛ represents a coefficient for use in calculating the temperature of the coil 109 in a simple manner.

The coefficient Kₛ is calculated by an experiment. For example, the measurer measures the current value supplied to the coil 109 or the indicator current value output from the controller 210, the temperature of the coil 109, and the temperature output from the thermistor 108.

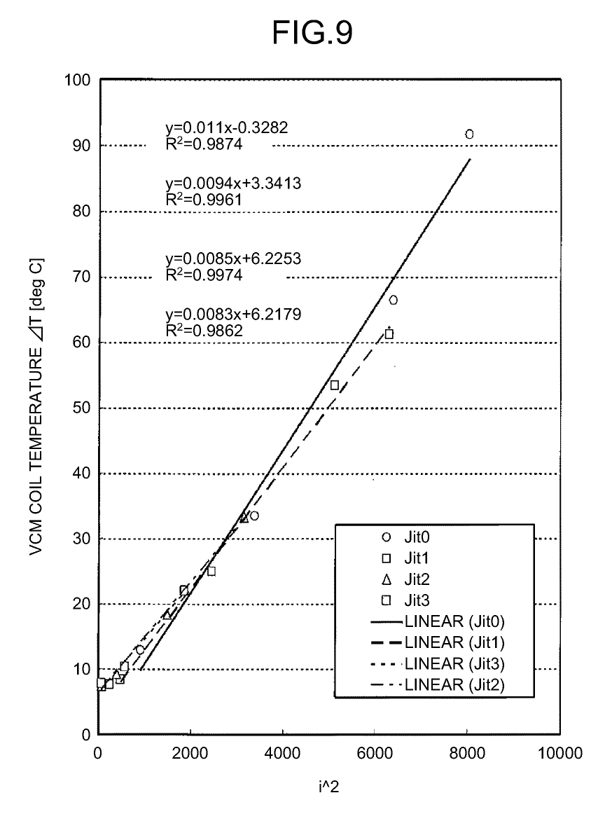

FIG. 9 is a graph representing a relation between an indicator current value and heat of the coil 109. The horizontal axis represents a square value of a sum value of current values, whilst the vertical axis represents a difference between an estimated value of the temperature of the coil 109 and the temperature output from the thermistor 108.

Measurement conditions are assumed to be identical to those in the experiment in FIG. 8. The measurer finds an approximate straight line from a point of measurement, which represents the measurement results. From the gradient of the approximate straight line, the measurer finds a coefficient Kₛ that relates a value obtained from the difference between the estimated value of the temperature of the coil 109 and the temperature output from the thermistor 108 and a value, which is the square of a sum value of currents flowing through the coil 109, together. For the coefficient Kₛ, the relation between the current flowing through the coil 109 and the difference in temperature varies, compared with the technique of taking changes in the resistance value of the coil 109 due to changes in temperature of the coil 109 into consideration. Therefore, when it is important to correctly obtain the temperature of the coil 109, the controller 210 finds the temperature of the coil 109 though the technique of taking changes in resistance value of the coil 109 due to changes in temperature of the coil 109 into consideration. On the other hand, when it is important to reduce the processing time of the program, the controller 210 finds the temperature of the coil 109 with the coefficient Kₛ.

The difference in temperature between the temperature “T_{coil}” of the coil 109 and the temperature “Tₜₕ” of the thermistor 108 is found by multiplying the square of the current “i” by the predetermined value Kₛ. The calculation to find the temperature only by multiplying the square of the current value by the coefficient takes a shorter calculation time than a calculation time to be taken to find the temperature from the resistance of the coil 109 and the temperature coefficient of the coil 109.

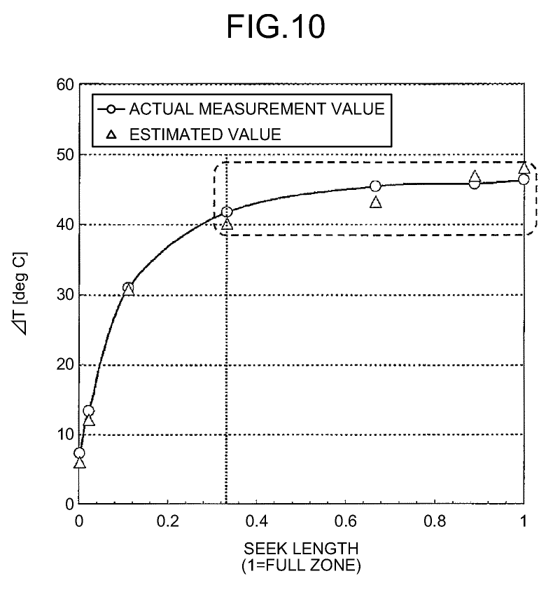

FIG. 10 is a graph representing a relation between a moving distance across tracks in a seek operation, and an actual measurement value in temperature increase of the coil 109 and an estimated value in temperature increase of the coil 109 according to the present embodiment. The horizontal axis represents a value of a seek distance in ratio. A seek length of 1 indicates a seek from the most inner track to the most outer track. A seek length of 0.2 represents a seek operation of moving across twenty percent of the number of all tracks, A seek length of 0.4 represents a seek operation of moving across forty percent thereof, A seek length of 0.6 represents a seek operation of moving across sixty percent thereof, and A seek length of 0.8 represents a seek operation of moving across eighty percent thereof.

The vertical axis represents a difference between the value of the temperature of the coil 109 and the value of the temperature of the thermistor 108. The actual measurement value indicates a temperature actually measured. The estimated value is a value calculated by the controller 210 with Equation (3). The actual measurement value and the estimated value approximately coincide each other.

The relation between the seek distance and temperature increase changes at a seek operation of moving across one thirds of the number of all tracks (one-thirds zone seek) as a boundary. In such a seek operation of moving across one thirds of the number of all tracks, the difference between the temperature of the coil 109 and the temperature of the thermistor 108 becomes 40 degrees Celsius to 50 degrees Celsius. On the other hand, for a distance shorter than the one-thirds zone seek, the difference between the temperature of the coil 109 and the temperature of the thermistor 108 becomes 5 degrees Celsius to 40 degrees Celsius. Therefore, in the case of a short-distance seek operation, an increase in temperature of the coil 109 is restricted. Here, the controller 210 can also be configured to measure the temperature of the coil 109 when detecting a repetition of a seek operation for a distance exceeding a one-thirds zone seek.

Temperature and Indicator Current Value

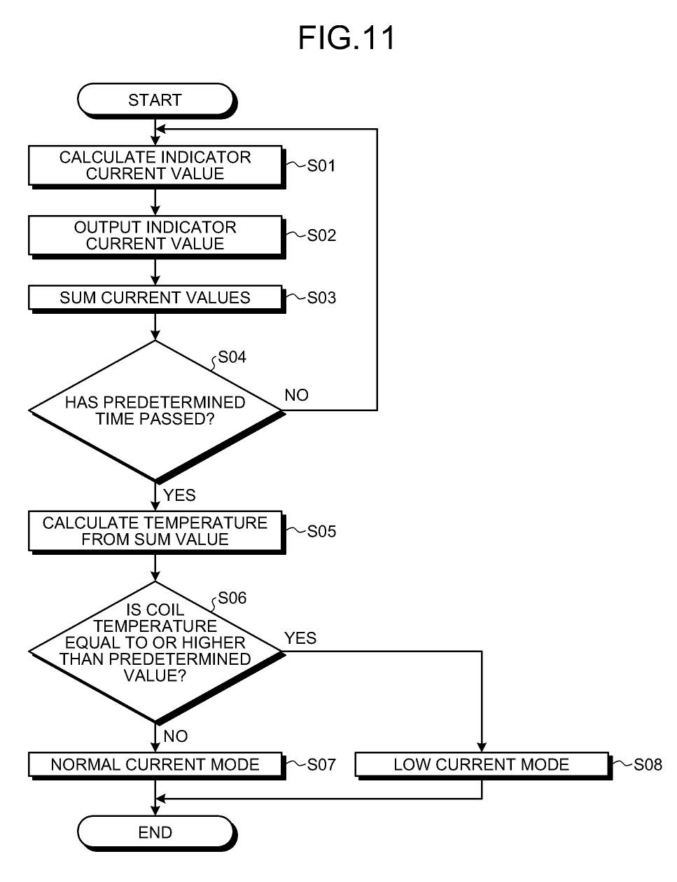

Next, a control change process in a seek operation executed by the controller 210 is explained. FIG. 11 is a flowchart of a control change process in a seek operation. The controller 210 changes a control mode according to the temperature of the coil 109. Specifically, when the temperature of the coil 109 becomes a predetermined value or higher, the controller 210 decreases an indicator current value to be supplied to the coil 109.

The controller 210 calculates an indicator current value to be supplied to the coil 109 (Step S01). For example, the controller 210 obtains the current position obtained by the magnetic head 103 from the RDC 230, and calculates, from a difference between the current position and the target position, an amount of current required for moving the magnetic head 103 to the target position.

The controller 210 outputs to the SVC 240 the indicator current value to be supplied to the coil 109 (Step S02). The controller 210 then sums indicator current values (Step S03). For example, the controller 210 sets in advance a region of the memory 220 in which a sum value of indicator current values is stored. The controller 210 then reads the sum value of indicator current values every time an indicator current value is output to the SVC 240, and adds an absolute value of the indicator current value output to the SVC 240 to the sum value of indicator current values, thereby updating the sum value of indicator current values in the set region of the memory 220.

The controller 210 then determines whether a predetermined time has passed (Step S04). The predetermined time is one second, for example. Also, when the controller 210 determines the current value every time passing over servo information on the magnetic disk 102, when making an instruction of a current value for a plurality of times, the controller 210 can determine that the predetermined time has passed. Also, it can be determined from the number of revolutions of the spindle motor 101 that the time has passed. If the predetermined time has not yet passed (No at Step S04), the controller 210 returns to S01 to perform the process of summing current values. On the other hand, if the predetermined time has passed (Yes at Step S04), the controller 210 calculates a temperature of the coil 109 from the sum value of indicator current values (Step S05).

The controller 210 then determines whether the calculated temperature of the coil 109 is equal to or higher than predetermined value (Step S06). The predetermined value is, for example, defined by a designer measuring in advance a relation between the performance of the VCM 106 and the temperature of the coil 109. When the temperature of the coil 109 is lower than the predetermined value (No at Step S06), the controller 210 performs position control over the magnetic head 103 in a mode of letting a normal current flow through the coil 109 (Step S07). When the temperature of the coil 109 is equal to or higher than the predetermined value (Yes at Step S06), the controller 210 performs position control over the magnetic head 103 in a mode of letting a current flow through the coil 109 less than that in the mode of letting a normal current flow through the coil 109 (Step S08). For example, the controller 210 decrease the amount of current to be supplied to the coil 109 when causing the magnetic head 103 to seek. With this, the controller 210 can suppress an increase in temperature of the coil 109.

When a circuit that detects a counter electromotive voltage of the coil is placed in the magnetic disk device, the controller can calculate the temperature of the coil from the detected counter electromotive voltage of the coil. For example, the temperature of the coil is estimated from a resistance value of the coil calculated by dividing the counter electromotive voltage by the value of current flowing through the coil. However, the counter electromotive voltage is a voltage generated when the coil moves. Therefore, when the moving speed of the coil is “0”, the counter electromotive voltage is also “0”. Thus, when the coil moves little, the resistance of the coil cannot be estimated. On the other hand, the controller 210 according to the present embodiment estimates the temperature of the coil 109 from the current value flowing through the coil 109. Therefore, the controller 210 of the present embodiment can correctly calculate the temperature of the coil 109 even when the coil 109 does not move in a magnetic field.

The controller 210 estimates the temperature of the coil from the indicator value of the VCM current. Therefore, for example, when successive seeks occur, the controller can perform a process of predicting the temperature of the coil and decreasing in advance the indicator value of the VCM current according to an increase in temperature of the coil. Note that the controller can estimate the temperature of the coil even with one seek operation, for example.

Also, the controller 210 of the present embodiment can correctly calculate the temperature of the coil 109 only with an addition of the function of the control program 221. As a result, the magnetic disk device 10 of the present embodiment can estimate the temperature of the coil without adding a circuit for detecting a counter electromotive voltage or changing circuitry inside a Large-Scale Integrated circuit (LSI).

A storage device according to an embodiment of the present invention can accurately estimate the temperature of the coil.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A storage device comprising:
a head that reads and writes data stored in a storage medium;
an arm that holds the head;
a voice coil motor that includes a coil and a magnet, and moves the arm according to current flowing through the coil;
a disk enclosure that accommodates the storage medium, the head, the arm, and the voice coil motor;
a temperature sensor that detects a temperature in the disk enclosure; and
a controller that determines an amount of current flowing through the coil for moving the head to a target position on the storage medium and estimates a temperature of the coil from the amount of current flowing through the coil, the temperature in the disk enclosure detected by the temperature sensor, and a predetermined value.

2. The storage device according to claim 1, wherein
the controller estimates the predetermined value from a thermal resistance of the coil, a reference temperature, a resistance value of the coil at the reference temperature, and a temperature coefficient of the coil.

3. The storage device according to claim 1, wherein
the controller sums amounts of current flowing through the coil for a predetermined period, and estimates a temperature of the coil for every predetermined period.

4. The storage device according to claim 1, wherein
the controller decreases the amount of current to be supplied to the coil, when the temperature of the coil is equal to or greater than a predetermined value.

5. The storage device according to claim 1, wherein
the controller estimates the temperature of the coil when the head repeats a seek operation of moving tracks as many as one third of the number of all tracks.

6. A method of controlling a storage device including a head that reads and writes data stored in a storage medium; an arm that holds the head; a voice coil motor formed of a coil and a magnet, the voice coil motor supplying a current to the coil to move the arm; a disk enclosure that accommodates the storage medium, the head, the arm, and the voice coil motor; a temperature sensor that detects a temperature in the disk enclosure; and a controller that determines an amount of current to be supplied to the voice coil motor, the method comprising:
determining the mount of current flowing through the coil for moving the head to a target position on the storage medium; and
estimating the temperature of the coil from the amount of current flowing through the coil, the temperature in the disk enclosure detected by the temperature sensor, and a predetermined value.

7. A control circuit for a storage device including a head that reads and writes data stored in a storage medium; an arm that holds the head; a voice coil motor formed of a coil and a magnet, the voice coil motor moving the arm according to a current flowing through the coil; a disk enclosure that accommodates the storage medium, the head, the arm, and the voice coil motor; and a temperature sensor that detects a temperature in the disk enclosure, wherein the control circuit determines the amount of current flowing through the coil to move the head to a target position on the storage medium, and
the control circuit estimates a temperature of the coil from the amount of current flowing through the coil, a temperature in the disk enclosure detected by the temperature sensor, and a predetermined value.
